(19) United States
(12) Patent Application Publication
(10) Pub. No.: US 2026/0310669 A1
(43) Pub. Date: Oct. 8, 2026

(54) OPTIMIZED DATA STRUCTURES FOR ACCELERATING QUERY EXECUTION BY A DATA SYSTEM

(71) Applicant: Dremio Corporation, Santa Clara, CA (US)

(72) Inventors: Max Lerch, Seattle, WA (US); Rafay Qureshi, Livermore, CA (US); Rahim Bhojani, Austin, TX (US); Tomer Shiran, Mountain View, CA (US)

(21) Appl. No.: 19/641,734

(22) Filed: Apr. 8, 2026

Related U.S. Application Data
(60) Provisional application No. 63/785,463, filed on Apr. 8, 2025.

(51) Int. Cl. G06F 16/2453; G06F 16/21; G06N 20/00

(52) U.S. Cl. CPC G06F 16/24542; G06F 16/217; G06N 20/00

(57) ABSTRACT

Varius examples of a method include: collecting, by computing hardware, query usage information; generating, by the computing hardware, based on the query usage information, a recommendation as to the generation of a potential new optimized data structure; performing, by the computing hardware, cost-benefit analysis for the potential new optimized data structure and each optimized data structure in a set of existing optimized data structures; modifying by the computing hardware, the set of existing optimized data structures based on the recommendation and the cost-benefit analysis; maintaining, by the computing hardware, the set of existing optimized data structures; using, by the computing hardware, the set of existing optimized data structures to accelerate a query by inserting at least a portion of at least one optimized data structure in the set of existing optimized data structures into a query plan for the query.

### CROSS REFERENCE TO RELATED APPLICATIONS

This application claims the benefit of U.S. Provisional Patent Application No. 63/785,463, filed Apr. 8, 2025, the disclosure of which is hereby incorporated herein by reference in its entirety.

### TECHNICAL FIELD

The present disclosure involves computer-implemented systems and processes for accelerating query executions in data systems. The disclosed teachings more particularly relate to a relational cache that has learning capabilities to automatically generate optimized data structures that are adaptable to accelerate query executions by a data system.

### BACKGROUND

A significant technical challenge encountered by computing systems is providing query responses that encompass data from a large number of computing systems. For example, the computational cost of obtaining query results that include data from a large number of computing systems may increase with the number of computing systems. Additionally, query response times may increase as the number of computing systems on which data responsive to a particular query is stored. Therefore, a need exists in the art for improved systems and methods for reducing query costs and response times while still delivering accurate query results.

### SUMMARY

A method comprising, according to various embodiments, comprises: (1) identifying, by computing hardware, a modification to an Iceberg table; (2) accessing, by the computing hardware, a set of optimized data structures that are dependent on the Iceberg table; (3) accessing, by the computing hardware, a set of table refresh rules; and (4) modifying, by the computing hardware, the set of optimized data structures based on the modification to the Iceberg table according to the set of table refresh rules. In some embodiments, identifying the modification to the Iceberg table comprises checking an iceberg table snapshot for the Iceberg table according to a schedule; and comparing the iceberg table snapshot to a previous refresh point for each optimized data structure in the set of optimized data structures. In various embodiments, the method comprises triggering the modification to the set of optimized data structures in response to determining that each optimized data structure in the set of optimized data structures has not been refreshed based on the comparison.

In some embodiments, the method comprises enabling, by the computing hardware, a user to provide, for each optimized data structure in the set of optimized data structures, an optimized data structure modification preference. In particular embodiments, the optimized data structure modification preference comprises an automation of the modification. In various embodiments, the optimized data structure modification preference comprises providing an indication of the modification to the Iceberg table, and a requirement that the user authorizes each modification to the set of optimized data structures.

In some embodiments, the method comprise: (1) receiving, by the computing hardware, a query; (2) identifying a first optimized data structure and a second optimized data structure in the set of optimized data structures that can be used to accelerate the query; (3) determining that the first optimized data structure is currently in a modification process based on the modification to the Iceberg table; and (4) modifying a query plan for the query by including a reference to at least a portion of the second optimized data structure but not a portion of the first optimized data structure.

A method, according to various embodiments, comprises: (1) monitoring, by computing hardware, respective workload data for a set of queries; (2) filtering, by the computing hardware, the set of queries based on a set of criteria and the respective workload data; (3) analyzing, by the computing hardware, usage pattern and frequency data based on the filtering for the set of queries; (4) categorizing, by the computing hardware, one or more query plan fragments from the set of queries; and (5) causing, by the computing hardware, at least one of a rules-based model or a machine-learning model to process the one or more plan fragments, the usage pattern and frequency data, and the respective workload data to generate a recommendation as to generation of an optimized data structure for use in accelerating one or more future queries.

In some embodiments, the method comprises: (1) traversing the one or more query plan fragments for each query in the set of queries to collect profile information for each query; and (2) generating the recommendation as to generation of the optimized data structure for use in accelerating one or more future queries based on the profile information. In some embodiments, the profile information comprises at least one of optimized data structure status for each query, function type for each of the one or more query plan fragments for each query, or top-level view components for each query.

In various embodiments, the method comprise: (1) scanning each of the one or more query plan fragments for each query from the bottom-up; (2) identifying fragment sections in the one or more query plan fragments containing multi-join operations; and (3) generating the recommendation as to generation of the optimized data structure for use in accelerating one or more future queries such that the recommendation incudes the identified fragment sections in the one or more query plan fragments containing multi-join operations.

In various embodiments, the recommendation as to generation of the optimized data structure for use in accelerating one or more future queries comprises a potential new optimized data structure. In some embodiments, the method further comprises: (1) determining, by computing hardware, for the potential new optimized data structure and each respective existing optimized data structure in a set of existing optimized data structures, a respective query acceleration impact; (2) determining, by the computing hardware based on the respective query acceleration impact for the potential new optimized data structure and each respective existing optimized data structure in a set of existing optimized data structure, a respective query performance improvement factor; (3) generating, by the computing hardware based on the respective query performance improvement factor for the potential new optimized data structure and each respective existing optimized data structure in a set of existing optimized data structure, a respective comparative optimized data structure improvement score; (5) normalizing, by the computing hardware, each respective comparative optimized data structure improvement score; and (6) modifying, by the computing hardware the recommendation based on a comparison of each respective comparative optimized data structure improvement score.

A method, in some embodiments, comprises: (1) identifying, by computing hardware, a potential new optimized data structure for use in accelerating one or more future queries; (2) determining, by computing hardware, for the potential new optimized data structure and each respective existing optimized data structure in a set of existing optimized data structures, a respective query acceleration impact; (3) determining, by the computing hardware based on the respective query acceleration impact for the potential new optimized data structure and each respective existing optimized data structure in a set of existing optimized data structures, a respective query performance improvement factor; (4) generating, by the computing hardware based on the respective query performance improvement factor for the potential new optimized data structure and each respective existing optimized data structure in a set of existing optimized data structures, a respective comparative optimized data structure improvement score; and (5) normalizing, by the computing hardware, each respective comparative optimized data structure improvement score.

In some embodiments, normalizing each respective comparative optimized data structure improvement score comprises modifying each respective comparative optimized data structure improvement score based on at least one of an age or a refresh frequency each respective existing optimized data structure in the set of existing optimized data structures. In particular embodiment, determining the respective query acceleration impact comprises comparing execution of at least one query both with and without using at least a portion of the potential new optimized data structure and each respective existing optimized data structure in the set of existing optimized data structures. In other embodiments, determining the respective query performance improvement factor comprises analyzing at least one of a usage frequency, average query savings, or total query savings for each respective existing optimized data structure in the set of existing optimized data structures. In particular embodiment, determining the respective query performance improvement factor comprises analyzing at least one of the usage frequency, the average query savings, or the total query savings for each respective existing optimized data structure in the set of existing optimized data structures over a particular time period.

A method, in various embodiments, comprises: (1) identifying, by computing hardware, a potential new optimized data structure for use in accelerating one or more future queries; (2) determining, by computing hardware, for the potential new optimized data structure and each respective existing optimized data structure in a set of existing optimized data structures, a respective query acceleration impact; (3) determined, by the computing hardware based on the respective query acceleration impact for the potential new optimized data structure and each respective existing optimized data structure in a set of existing optimized data structure, a respective query performance improvement factor; (4) generating, by the computing hardware based on the respective query performance improvement factor for the potential new optimized data structure and each respective existing optimized data structure in a set of existing optimized data structures, a respective comparative optimized data structure improvement score; (5) normalizing, by the computing hardware, each respective comparative optimized data structure improvement score; (6) applying, by the computing hardware, based on each respective normalized comparative optimized data structure improvement score, a decision-making algorithm to identify an optimal set of optimized data structures; (7) generating, based on the optimal set of optimized data structures, an optimized data structure generation plan; and (8) implementing, by the computing hardware, at least one step of the optimized data structure generation plan.

In some embodiments, implementing at least one step of the optimized data structure generation plan includes modifying the set of existing optimized data structures to include the potential new optimized data structure and exclude a particular one of the set of existing optimized data structure. In various embodiments, applying the decision-making algorithm comprises applying a set of selection criteria. In particular embodiment, the set of selection criteria comprise at least one of the respective query performance improvement factor; a respective usage count for each respective existing optimized data structure in the set of existing optimized data structures; or a refresh frequency for each respective existing optimized data structure in the set of existing optimized data structures. In various embodiments, applying the decision-making algorithm comprises causing at least one of a rules-based model or a machine learning model to process the set of selection criteria and each respective normalized comparative optimized data structure improvement score to identify the optimal set of optimized data structures. In particular embodiment, the optimal set of optimized data structures comprises the set of optimized data structures that provide the greatest cost-savings with respect to system resource availability.

In some embodiments, the method includes: (1) monitoring, by computing hardware, respective workload data for a set of queries; (2) filtering, by the computing hardware, the set of queries based on a set of criteria and the respective workload data; (3) analyzing, by the computing hardware, usage pattern and frequency data based on the filtering for the set of queries; (4) categorizing, by the computing hardware, one or more query plan fragments from the set of queries; and (5) causing, by the computing hardware, at least one of a rules-based model or a machine-learning model to process the one or more plan fragments, the usage pattern and frequency data, and the respective workload data to generate a recommendation as to generation of an optimized data structure for use in accelerating the one or more future queries, wherein the recommendation as to the generation of the optimized data structure for use in accelerating the one or more future queries comprises the potential new optimized data structure.

A method, in various embodiments, comprises: (1) collecting, by computing hardware, query usage information; (2) generating, by the computing hardware, based on the query usage information, a recommendation as to the generation of a potential new optimized data structure; (3) performing, by the computing hardware, cost-benefit analysis for the potential new optimized data structure and each optimized data structure in a set of existing optimized data structures; (4) modifying by the computing hardware, the set of existing optimized data structures based on the recommendation and the cost-benefit analysis; (5) maintaining, by the computing hardware, the set of existing optimized data structures; and (6) using, by the computing hardware, the set of existing optimized data structures to accelerate a query by inserting at least a portion of at least one optimized data structure in the set of existing optimized data structures into a query plan for the query.

In some embodiments, collecting the query usage information comprises: monitoring, by the computing hardware, respective workload data for a set of queries; filtering, by the computing hardware, the set of queries based on a set of criteria and the respective workload data; analyzing, by the computing hardware, usage pattern and frequency data based on the filtering for the set of queries; and categorizing, by the computing hardware, one or more query plan fragments from the set of queries. In some embodiments, generating, by the computing hardware, based on the query usage information, the recommendation as to the generation of a potential new optimized data structure comprises causing, by the computing hardware, at least one of a rules-based model or a machine-learning model to process the one or more plan fragments, the usage pattern and frequency data, and the respective workload data to generate the recommendation as to generation of an optimized data structure for use in accelerating the one or more future queries, wherein the recommendation as to the generation of the optimized data structure for use in accelerating the one or more future queries comprises the potential new optimized data structure.

In various embodiments, performing the cost-benefit analysis for the potential new optimized data structure and each optimized data structure in the set of existing optimized data structures comprises: (1) determining, by the computing hardware, for the potential new optimized data structure and each respective existing optimized data structure in a set of existing optimized data structures, a respective query acceleration impact; (2) determining, by the computing hardware based on the respective query acceleration impact for the potential new optimized data structure and each respective existing optimized data structure in a set of existing optimized data structures, a respective query performance improvement factor; (3) generating, by the computing hardware based on the respective query performance improvement factor for the potential new optimized data structure and each respective existing optimized data structure in a set of existing optimized data structures, a respective comparative optimized data structure improvement score; and (4) normalizing, by the computing hardware, each respective comparative optimized data structure improvement score. In some embodiments, normalizing each respective comparative optimized data structure improvement score comprises modifying each respective comparative optimized data structure improvement score based on at least one of an age or a refresh frequency each respective existing optimized data structure in the set of existing optimized data structures. In other embodiments, determining the respective query acceleration impact comprises comparing execution of at least one query both with and without using at least a portion of the potential new optimized data structure and each respective existing optimized data structure in the set of existing optimized data structures. In still other embodiments, determining the respective query performance improvement factor comprises analyzing at least one of a usage frequency, average query savings, or total query savings for each respective existing optimized data structure in the set of existing optimized data structures.

In various embodiments, modifying the set of existing optimized data structures based on the recommendation and the cost-benefit analysis comprises: applying, by the computing hardware, based on each respective normalized comparative optimized data structure improvement score, a decision-making algorithm to identify an optimal set of optimized data structures; generating, based on the optimal set of optimized data structures, an optimized data structure generation plan; and implementing, by the computing hardware, at least one step of the optimized data structure generation plan.

In some embodiments, implementing the at least one step of the optimized data structure generation plan includes modifying the set of existing optimized data structures to include the potential new optimized data structure and exclude a particular one of the set of existing optimized data structures.

In particular embodiments, applying the decision-making algorithm comprises applying a set of selection criteria. In some embodiments, the set of selection criteria comprise at least one of the respective query performance improvement factor; a respective usage count for each respective existing optimized data structure in the set of existing optimized data structures; or a refresh frequency for each respective existing optimized data structure in the set of existing optimized data structures.

In various embodiments, applying the decision-making algorithm comprises causing at least one of a rules-based model or a machine learning model to process the set of selection criteria and each respective normalized comparative optimized data structure improvement score to identify the optimal set of optimized data structures.

In some embodiments, the optimal set of optimized data structures comprises the set of optimized data structures that provide the greatest cost-savings with respect to system resource availability. In particular embodiment, inserting the at least a portion of the at least one optimized data structure in the set of existing optimized data structures into the query plan for the query comprises substituting the at least one optimized data structure in the set of existing optimized data structures into at least one plan segment of the query plan in lieu of a reference to an underlying data structure.

In some embodiments, the method comprise: (1) identifying, by computing hardware, a modification to an Iceberg table; (2) determining, by the computing hardware, which of the set of existing optimized data structures that are dependent on the Iceberg table; (3) accessing, by the computing hardware, a set of table refresh rules; and (4) modifying, by the computing hardware, the set of existing optimized data structures based on the modification to the Iceberg table according to the set of table refresh rules.

A method, according to particular embodiments, comprises: (1) receiving, by computing hardware, a query; (2) generating, by the computing hardware, a query plan for the query that includes a query tree; (3) computing, by the computing hardware, a hash of at least one top-level binary node in the query plan; (4) accessing, by the computing hardware, a set of optimized data structures; (5) computing, by the computing hardware, for each optimized data structure in the set of optimized data structures, a respective optimized data structure hash of at least one respective top-level binary node for each optimized data structure; (6) comparing, by the computing hardware, the hash with each respective optimized data structure hash; and (7) responsive to identifying a match between the hash and a particular respective optimized data structure hash, integrating at least a portion of the respective optimized data structure identified by the particular respective optimized data structure hash into the query plan.

In some embodiments, the method comprises implementing, by the computing hardware, a bottom-up query plan unification to the query plan to integrate a portion of a particular optimized data structure based on comparing the hash with each respective optimized data structure hash. In other embodiments, the method further comprises traversing the query tree top-down to identify a first node of a first node type; and the at least one top-level binary node in the query plan comprises the first node of the first type. In particular embodiment, the first type comprises at least one of a join or a union.

In various embodiments, the method further comprises traversing each optimized data structure in the set of optimized data structures to identify a respective second node of the first node type; and the at least one respective top-level binary node for each optimized data structure comprises the respective second node of the first type. In some embodiments, the method comprises performing algebraic matching for one or more nodes above the at least one top-level binary node in the query plan to identify at least one respective optimized data structure that can be integrated into the query plan. In some embodiments, the method comprises traversing the query tree from top to the at least one top-level binary node. In some embodiments, the method comprises ceasing traversal of the query tree at the at least one top-level binary node.

In some embodiments, the method comprises using, by the computing hardware, the particular respective optimized data structure to accelerate the query by inserting at least a portion of particular respective optimized data structure into the query plan. In various embodiments, the method comprises, prior to integrating the at least a portion of the respective optimized data structure identified by the particular respective optimized data structure hash into the query plan, confirming a refresh status of the respective optimized data structure.

A method, in some embodiments, comprises: (1) receiving, by computing hardware, a query; (2) generating, by the computing hardware, a query plan for the query that includes a query tree; (3) traversing, by the computing hardware, the query tree top-down to identify a first top level binary node; (4) computing, by the computing hardware, a hash of the first top level binary node; (5) accessing, by the computing hardware, a set of optimized data structures; (6) computing, by the computing hardware, for each optimized data structure in the set of optimized data structures, a respective optimized data structure hash of at least one respective top-level binary node for each optimized data structure; (7) comparing, by the computing hardware, the hash with each respective optimized data structure hash; and (8) responsive to identifying a match between the hash and a particular respective optimized data structure hash, integrating at least a portion of the respective optimized data structure identified by the particular respective optimized data structure hash into the query plan.

In some embodiments, the first top level binary node comprises at least one of a join or a union. In various embodiments, the method comprises performing algebraic matching between at least one node disposed above the first top level binary node and each optimized data structure in the set of optimized data structures. In particular embodiments, the method comprises ceasing traversal of the query tree at the first top level binary node.

### BRIEF DESCRIPTION OF THE DRAWINGS

In the course of this description, reference will be made to the accompanying drawings, which are not necessarily drawn to scale, and wherein:

FIG. 1A is a block diagram that illustrates a data system according to various embodiments of the present disclosure;

FIG. 1B is a block diagram that illustrates a data system including a data lake according to some embodiments of the present disclosure;

FIG. 2 is a block diagram that illustrates tiered processing by a data system to accelerate query executions according to some embodiments of the present disclosure;

FIG. 3 is a flow diagram that illustrates a process for accelerating a query execution with an optimized data structure according to some embodiments of the present disclosure;

FIG. 4 is a flow diagram that illustrates a process for accelerating a query execution with a complex interconnection of optimized data structures according to some embodiments of the present disclosure;

FIG. 5 depicts an example of a process for collecting query usage information in accordance with various aspects of the present disclosure;

FIG. 6 depicts an example of a process for generating recommendations related to the generation of new optimized data structures in accordance with various aspects of the present disclosure;

FIG. 7 depicts an example of a process for analyzing query acceleration impact of optimized data structures in accordance with various aspects of the present disclosure;

FIG. 8 depicts an example of a process for modifying a set of optimized data structures to create new optimized data structures and/or drop existing optimized data structures based on efficacy analysis;

FIG. 9 depicts an example of a process for maintaining and refreshing optimized data structures in response to modifications of the underlying data in accordance with various aspects of the present disclosure;

FIG. 10 depicts an example of a process for accelerating queries using optimized data structures in accordance with various aspects of the present disclosure;

FIG. 11 depicts an example of a process for matching optimized data structures with queries for use in accelerating the queries in accordance with various aspects of the present disclosure;

FIG. 12 depicts an example of a process for autonomously creating, dropping, and maintaining optimized data structures in accordance with various aspects of the present disclosure; and

FIG. 13 is a diagrammatic representation of a computing system which can implement some embodiments of the present disclosure.

### DETAILED DESCRIPTION

As discussed above, a significant technical challenge encountered by computing systems is providing query responses that encompass data from a large number of computing systems. For example, the computational cost of obtaining query results that include data from a large number of computing systems may increase with the number of computing systems. Additionally, query response times may increase as the number of computing systems on which data responsive to a particular query is stored. In some embodiments, optimized data structures include precomputed summaries of tables and views that can be substituted into query plans in order to reduce the computational cost of responding to queries. In particular embodiments, a query optimizer may accelerate queries by utilizing the one or more optimized data structures in lieu of accessing the underlying data at the source. In this way, a data system may generate and maintain optimized data structures for use in accelerating queries.

The generation and maintenance of optimized data structures, however, require the use of computing resources in terms of identification, creation, and maintenance. As such, there are additional technical challenges related to identifying potential optimized data structures, determining which optimized data structures provide sufficient computational cost savings to justify their creation and maintenance, and identifying optimized data structures that are no longer with maintaining. Various embodiment of the present disclosure provide improved systems and methods for generating and maintaining optimized data structures and reducing costs associated with serving query responses.

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. These concepts and applications fall within the scope of the disclosure and the accompanying claims.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, may refer to any connection or coupling, either direct or indirect, between two or more elements. The coupling or connection between the elements can be physical, logical, or a combination thereof.

The disclosed embodiments include a relational cache with learning capabilities to automatically generate optimized data structures that are adaptable to accelerate query executions by a data system. In general, a data system is used for reporting and data exploration and analysis and is considered a core component of business intelligence (BI). A data system couples data sources and analysis/visualization tools typically accessible by users. The data system has analytics capabilities that enable entities (e.g., organizations, users, analysts, data scientists) to discover, curate, explore, and analyze diverse data from diverse data sources at any time.

The architecture of a data system can vary from IT-centric data systems to self-service data systems. An IT-centric architecture includes an extract, transform, and load (ETL) tool operable to pull data from disparate data sources and store the pulled data in a data warehouse or data lake. A BI tool can be used to query the data warehouse. An intermediate architecture may include an alternative storage such as HADOOP or cloud storage. The intermediate architecture includes data movement but offers a self-service BI tool for end-users. In contrast, a full self-service architecture replaces the ETL tool and data warehouse or alternative storage of the IT-centric architecture with a data system.

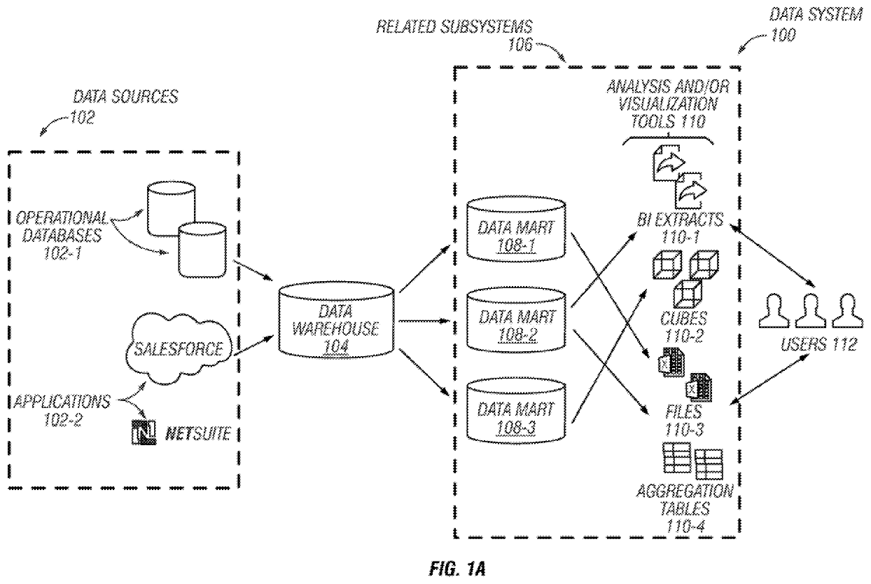

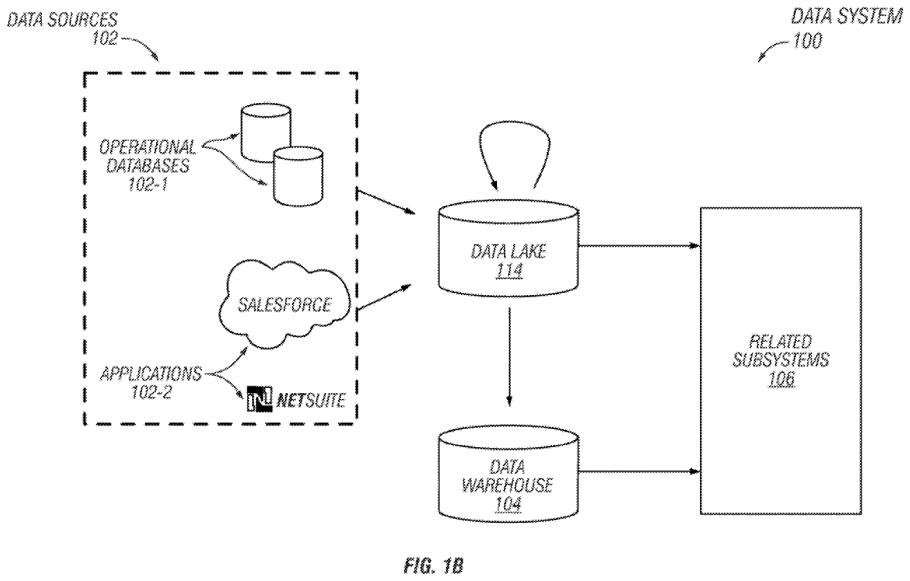

FIG. 1A is a block diagram that illustrates components and dataflows of a data system. The data system 100 includes one or more data sources 102, a data warehouse 104, and related subsystems 106 such as, for example, one or more data marts 108, and one or more analysis and/or visualization tools 110 for use by a variety of users 112. Examples of the data sources 102 include operational databases 102-1 and applications 102-2 (e.g., SALESFORCE, NETSUITE), as well as other file systems, data lakes, data warehouses, etc.

In some embodiments, the data system 100 can connect to a combination of data sources 102 including non-relational and/or relational databases, data warehouses, and spreadsheets to gather data in response to a query. The data system 100 can simultaneously or asynchronously query data from the data sources 102. Other examples of data sources include NOSQL sources (e.g., MONGODB, HBASE, CASSANDRA), search sources (e.g., ELASTICSEARCH, SOLR), file storage sources (e.g., HDFS, NAS, LINUX CLUSTER, EXCEL/CSV), cloud computing (e.g., IaaS, PaaS, SaaS) sources (e.g., AMAZON S3), relational sources (e.g., MySQL, SQL server), and SaaS sources (e.g., SALESFORCE, MARKETO, GOOGLE SHEETS, and GITHUB). Examples of analysis or visualization tools include an analyst center (e.g., self-service portal), BI tools (e.g., QLIK SENSE, TABLEAU, POWER BI) via ODBC/JDBC, data science tools (e.g., R, PYTHON) and custom applications via REST.

The data warehouse 104 is a central repository of integrated data from the data sources 102. The data warehouse 104 can store current and historical data and use that data to create analytical reports for an organization. In some instances, an ETL-based data system can use staging, data integration, and access layers to house key functions. The staging layer or staging database (not shown) stores raw data extracted from each of the data sources 102. The integration layer integrates disparate data sets by transforming the data from the staging layer often storing this transformed data in an operational data store (ODS) database. The integrated data are then moved to another database (e.g., data warehouse 104), where the data is arranged into hierarchical groups, often called dimensions (e.g., dimension tables), and into facts and aggregate facts (e.g., fact tables). The combination of facts and dimensions is sometimes called a star schema. A “schema,” as used herein, may refer to a structure that represents a logical view of an entire data store. It defines the organization of data and relationships among the data.

In some instances, the data obtained from data sources can be cleansed, transformed, catalogued, and made available to administrators or analysts for data mining, online analytical processing, research, and decision support. The broader means for retrieving, analyzing, and managing data could also be considered components of a data system. Thus, an expanded definition for a data system could include BI tools, tools to ETL data into a repository, and tools to manage and retrieve data.

The data marts 108 are each structure or access pattern specific to data warehouse environments and are used to retrieve client-facing data. In some instances, each of the data marts 108 is a subset of the data warehouse 104 and is usually oriented to a specific business unit (e.g., purchasing, sales, inventory functional areas). Hence, compared to an organization-wide data warehouse (e.g., data warehouse 104), the information in the data marts 108 pertains to a single business unit. In some deployments, each business unit is considered the owner of a specific data mart including all hardware, software, and data. This allows each business unit to isolate use, manipulation, and development of its data.

The analysis and/or visualization tools 110 may be utilized by users via BI software, which is a type of application software designed to retrieve, analyze, transform and report data for BI. The analysis and/or visualization tools generally read data that has been previously stored in, for example, the data warehouse 104 or the data marts 108. Examples of analyzation or visualization tools include spreadsheets, reporting and querying software (e.g., applications that extract, sort, summarize, and present selected data), online analytical processing (OLAP), digital dashboards, data mining, business activity monitoring, data warehouse, local information systems, data cleansing, or the like. Except for spreadsheets, the tools are typically standalone applications, suites of applications, components of enterprise resource planning systems, application programming interfaces, or components of software targeted to a specific industry. The tools are sometimes packaged into data warehouse appliances. The illustrated example includes BI extracts 110-1, cubes 110-2, files 110-3, and aggregation tables 110-4 that are available to the users 112 via BI software to perform analytics based on the data contained in the data warehouse 104 or data marts 108. For example, users can connect to and utilize the cubes 110-2, the files 110-3, and the aggregation tables 110-4 via BI tools to perform analytics based on the data contained in the data warehouse 104 or data marts 108. The BI tools can additionally visualize the BI extracts 110-1.

FIG. 1B is a block diagram that illustrates a representation of the data system 100 including a data lake. The data lake 114 (e.g., AMAZON S3, AZURE DATA LAKE STORE (ADLS), HADOOP FILE SYSTEM (HDFS)) is a system or repository of data stored in its natural format, usually object blobs or files. The data lake 114 is usually a single store of all enterprise data including raw copies of source system data and transformed data used for tasks such as reporting, visualization, analytics and machine learning. The data lake 114 can include structured data from relational databases (e.g., rows and columns), semi-structured data (e.g., CSV, logs, XML, JSON), unstructured data (e.g., emails, documents, PDFs) and binary data (e.g., images, audio, video).

The disclosed data system may include features that improve user experience as well as performance. Examples include data management and preparation, integration with diverse data sources, handling dynamic schemas, dataset namespace and path structures, exposing dataset information, data intelligence, user-defined data security, a relational cache memory for accelerating query executions, and a BI tool launcher. The data system may not require defining a schema, data model, or to ETL data to query a data source. A “data model,” as used herein, may refer to fundamental entities to introduce abstraction in a database management system. Data models can define how data is interconnected, processed, and stored in a data system.

In some embodiments, the data system 100 supports a range of structured query language (SQL) commands. SQL is a domain-specific language often used to interact with a database management system. SQL commands can be used to specify the desired query. SQL commands may include joins, correlated sub-queries, and window functions. The data system may be aware of data sources and their native capabilities to employ native query processes.

The disclosed data system can accelerate a query execution process to rapidly obtain query results that satisfy a query. For example, the data system 100 can create optimized data structures (also referred to herein as “reflections”) based on data obtained from the data sources to improve subsequent query executions. A user can use manage and explore processes to edit the reflections. The query results can undergo an analysis or visualization process in response to the query execution. For example, a BI tool can be used to visualize query results.

More specifically, a reflection refers to a materialization of data and the query plan defining that materialization. A query plan could be, for example, the equivalent of a SQL query “select customer, sum(amount) from purchases.” When the data system receives a query from a user device, an optimizer engine (“optimizer”) considers the query plans of the data reflections in a relational cache to determine whether it is possible to substitute part of the user's query plan with any reflections in order to reduce the query cost (e.g., reduce execution processing and/or time) while maintaining the same query results. This capability allows customers of a data system to experience performance improvements of many orders of magnitude on many workloads.

The disclosed embodiments may include different types of reflections. For example, a reflection anchored to a single dataset could be a raw reflection or an aggregation reflection. A raw reflection has all the records in a dataset but perhaps only some of its data columns, sorted, partitioned and distributed by specific columns. An aggregation reflection has aggregation (i.e., summarization) of a dataset similar to an OLAP cube with dimensions and measures. An aggregation reflection can be used to accelerate aggregation queries. Another type of optimized data structure is a sample reflection that has samples of data from a dataset. A sample reflection can be used by the data system to accelerate query processes by many orders of magnitude if a user allows for approximate query results (e.g., within 0.1% statistical error) based on sampled data.

The disclosed data system can determine whether to leverage reflections when defining or modifying a query plan based on a receive query. For example, the data system can compile a received SQL query from a client device to define a query plan. The query plan describes how the query will execute, including all operations needed in order to compute the query results. When the data system determines that any reflections can be used to accelerate a query, the data system may generate the query plan or modify a generated query plan to utilize the reflections rather than directly query data sources.

### Relational Cache Memory

Given the diverse needs of different data consumers in an organization, adopting a single, standard representation of data in a data warehouse for the organization is nearly impossible. Even when a centralized data warehouse exists, there is a need for different representations of the stored data for different use cases and users. As a result, data is often extracted and copied from a data warehouse (e.g., data warehouse 104) into data marts (e.g., data marts 108) and/or in other representations of data (e.g., business BI servers 110-1, cubes 110-2, spreadsheet files 110-3, aggregation tables 110-4). The rise of data lake techniques (e.g., using the data lake 114) make it easier to load data into a centralized repository but has exacerbated the aforementioned challenges by relaxing data modeling requirements and facilitating even more data copies through technologies such as data preparation tools and frameworks such as SPARK and MAPREDUCE.

In some embodiments, the disclosed technology overcomes these drawbacks by introducing a logical data tier, which enables users to curate data by creating and sharing virtual datasets without incurring the computing costs and risks associated with physical datasets. As used herein, a “physical dataset” may refer to raw data contained in data sources connected to the data system. As used herein, a “virtual dataset” refers to a dataset derived from physical dataset(s) or other virtual dataset(s). The data system does not need to save the data/content of a virtual dataset. Instead, the data system only needs to save the definition of a virtual dataset (e.g., a “SELECT” statement in SQL analogous to a database view). The virtual datasets are derivable from physical datasets or other virtual datasets, which can be defined via an SQL SELECT statement. By expanding all the virtual datasets recursively, any virtual dataset can be represented internally as a query plan (e.g., using relational algebra) on one or more physical datasets (e.g., PARQUET files, ORACLE tables, directories of CSV files on AMAZON S3, ELASTICSEARCH indices/types, MONGODB collections).

The disclosed data system can utilize reflections to accelerate a query execution compared to directly querying datasets contained in one or disparate data sources. For example, the disclosed data system can create reflections based on physical or virtual datasets. The reflections can reside in memory or on persistent storage. These reflections are referred to as a “relational cache” (also referred to herein as an “autonomous memory” or “reflections data store”). In some embodiments, a reflection can be created autonomously by the relational cache and/or manually by a user of the data system. That is, users can manually designate any combination of datasets to accelerate and/or the system may decide which reflections to create autonomously based on, for example, past queries and workloads for processing queries. In some embodiments, a reflection is anchored to at least one physical or virtual dataset. At query time, using a reflection can accelerate querying meant for any underlying source datasets.

The relational cache memory that stores the reflections is sometimes referred to as “autonomous” because the data system can autonomously decide to generate reflections that are stored in the autonomous memory for use to accelerate queries. When seeking to query a data source, the end-user does not need to consider any reflections or know of their existence. Rather, the use of reflections by the data system to accelerate a query is transparent to users. For example, when a query is received via a BI tool, an optimizer of the data system determines an optimal query execution plan (“query plan”), which may include pushing sub-queries down to data sources and/or utilizing reflections.

A reflection may contain data of any type or size. The data system knows the definition (i.e., logical plan) of the reflection, which allows the data system to refresh the data of the reflection and to determine, at query time, whether that reflection can accelerate the computation of the query results. The optimizer of the data system can identify an opportunity to leverage a reflection when there is a way to compute the query results from the reflection. In some embodiments, the optimizer may return an approximate query result within some user allowable tolerance when reflections are available for such approximation rather than obtaining exact results.

The data system may decide whether to create reflections autonomously, based on user input, or combinations thereof. For example, to facilitate management, the data system can have each reflection anchored to a specific dataset (physical or virtual). This facilitates the ability of an administrator to understand what a reflection contains and facilitates identifying queries on a dataset that are executing too slow such that a user can request creation of a reflection anchored to that highly queried dataset.

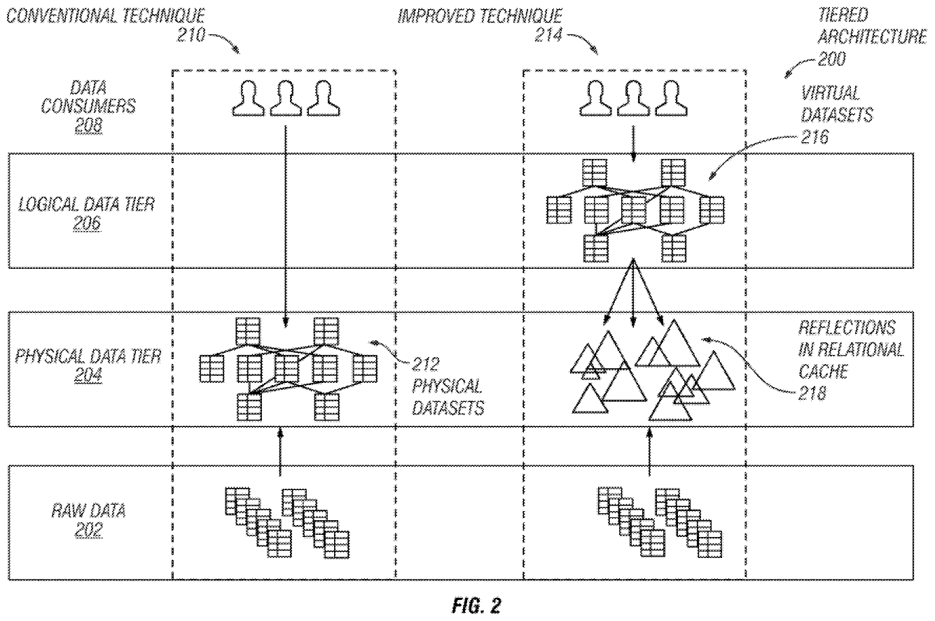

FIG. 2 is a block diagram that illustrates tiered processing by a data system to accelerate query executions. As shown, a tiered architecture separates a logical data tier from a physical data tier to improve query execution processing. From the bottom up on FIG. 2, the tiered architecture 200 has raw data 202, physical data tier 204, logical data tier 206, and data consumers 208. In the conventional technique 210, the data consumers 208 can access physical datasets 212 directly from a physical data tier 204. The physical datasets 212 may be derived from raw data 202.

In the improved technique 214, the data consumers 208 can access and query virtual datasets 216 from the logical data tier 206. As illustrated, the triangles of the relational cache 218 represent reflections. Hence, queries from the data consumers 208 may reference the virtual datasets 216 (represented by the tables in the logical data tier 206). A data system optimizer is responsible for rewriting the query plans, when possible, to leverage the data reflections, and to reduce the overall cost of executing the query.

The relational cache 218 is configured to create reflections based on data from data sources. The relational cache 218 contains the reflections that are used at query time rather than relying solely on querying data in the data sources. The relational cache 218 may include a combination or cluster of in-memory storage, on-disk storage, a distributed file system (e.g., HDFS), a blob or object store (e.g., AMAZON S3), or a database. The relational cache 218 is communicatively coupled to data sources and the data system (not shown in FIG. 2). The relational cache 218 can accelerate a query execution process upon receiving a query for data contained in data sources. Specifically, the relational cache 218 can be queried in lieu of querying data sources or in addition to querying the data sources. Hence, the process for obtaining query results is accelerated because the data system can avoid querying remote and/or disparate data sources.

The operations of the relational cache 218 are transparent to the data consumers 208. In some embodiments, a user of a device coupled to the data system can view or modify reflections by using the controls via a display, in which case the data system creates and stores the changed reflections in the relational cache for subsequent use during query time. The reflections contained therein enable a data system to accelerate queries from data consumers and tools. In some embodiments, the data system optimizer can “push down” queries to the underlying data sources; however, the data reflections provide optimized data structures that are more efficient for analytical queries.

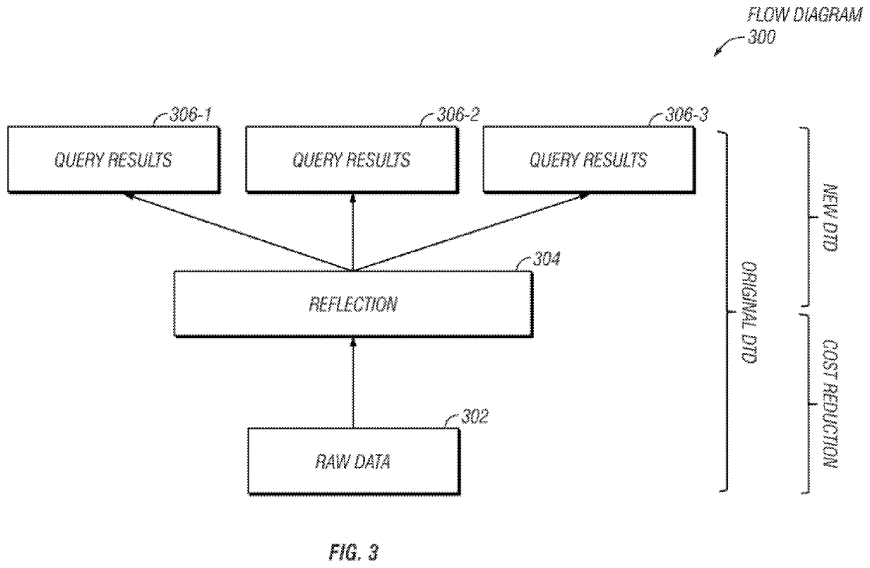

FIG. 3 is a flow diagram that illustrates a process for accelerating a query execution with a reflection stored in a relational cache. In the flow diagram 300, a reflection 304 is formulated based on raw data 302 via, for example, an arbitrary operator direct acyclic graph (DAG). The relational cache prioritizes the reflection 304 over the raw data 302 to efficiently and rapidly obtain query results 306 sought by the user. As shown, the different query results 306-1, 306-2, and 306-3 could be obtained from the same reflection 304 in response to one or more queries. As shown, the original distance-to-data (DTD) spans from the raw data 302 to the query results 306. Introducing the reflection 304 reduces costs and latency and shortens the DTD.

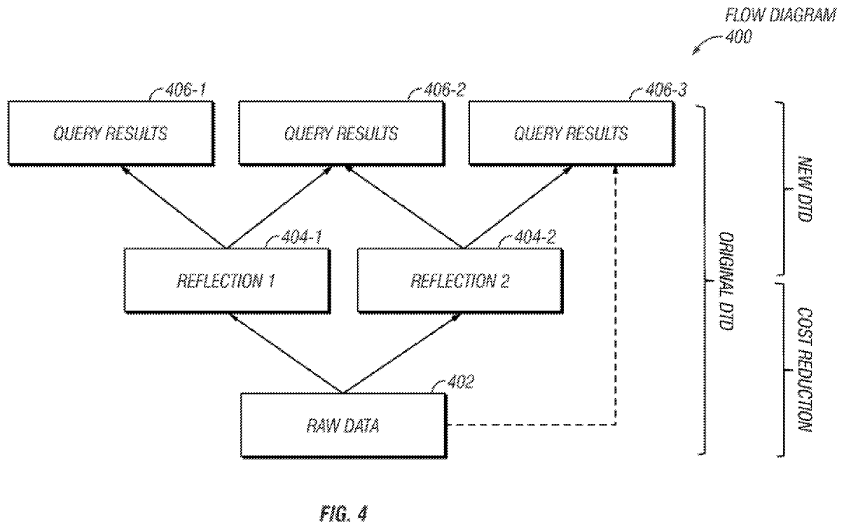

FIG. 4 is a flow diagram that illustrates a process for accelerating a query execution with a complex interconnection of reflections. In the flow diagram 400, two reflections 404-1 and 404-2 are formulated based on raw data 402 via, for example, an arbitrary operator DAG. The relational cache prioritizes the reflections 404 over the raw data 402 to efficiently and rapidly obtain the query results 406. The query result 406-1 is obtained from only the reflection 404-1, and the query result 406-3 is obtained from only the reflection 404-2. In contrast, the query result 406 is obtained from a combination of both the reflections 404-1 and 404-2. As shown, the original DTD spans from the raw data 402 to the query results 406 and introducing the reflection 304 shortens the DTD because of cost reductions.

### Query Usage Information Determination Module

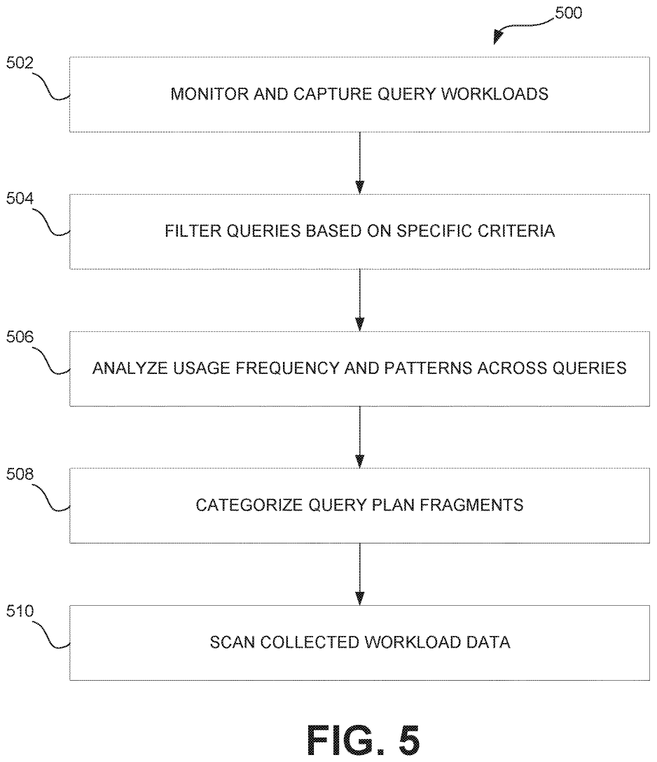

FIG. 5 depicts an example of processes performed by a query usage information determination module 500. This process includes operations that the data system 100 may execute to collect and analyze query usage information. For instance, the flow diagram shown in FIG. 5 may correspond to operations carried out, for example, by computing hardware found in the data system 100 as the computing hardware executes the query usage information determination module 500.

In some embodiments, at operation 502, the query usage information determination module 500 monitors and captures query workloads. In some embodiments, the data system 100 captures query workloads over a configurable time window. In particular embodiment, the configurable time window is based on a volume of queries received by the data system 100. In a particular embodiment, the time window may include a particular number of days (e.g., a seven day period).

At operation 504, the data system 100, when executing the query usage information determination module 500, filters queries based on specific criteria. In some embodiments, the system filters queries based on criteria such as whether the query takes longer than a threshold amount of time (e.g., longer than about 1 second). In some embodiments, the system filters queries based on a determination of whether each individual query uses a results cache or not. In other embodiments, the system filters queries based on whether the queries include aggregate operations or top-level views.

In various embodiment, at operation 506, the query usage information determination module 500 analyzes usage frequency and patterns across one or more queries. In some embodiments, the workload analysis techniques use reservoir sampling to maintain a perspective sample of up to a particular number of job identifiers per view and/or plan fragment. In some embodiments, the system tracks usage frequency for particular views and/or plan fragments across different queries. For example, query plan fragments that are utilized more often may provide opportunity for future acceleration by integrating such fragments into an optimized data structure as discussed herein.

In particular embodiments, at operation 508, the query usage information determination module 500 categorizes query plan fragments. In some embodiments, the system categorizes plan fragments based on join tables, join predicates, join types, and the like.

At operation 510, the query usage information determination module 500 scans collected workload data. The data system may, for example, scan the collected workload data to identify a set of frequently used views and/or plan fragments. The system may scan the workload data to identify a particular number of most frequently used views and/or plan fragments. In some aspects, the data system 100 may be configured to exclude views/fragments that are present in existing optimized data structures. In this way, the query usage information determination module 500 may be configured to identify query views/fragments that may provide benefit in terms of computing resource savings through integration into new optimized data structures.

### Optimized Data Structure Recommendation Module

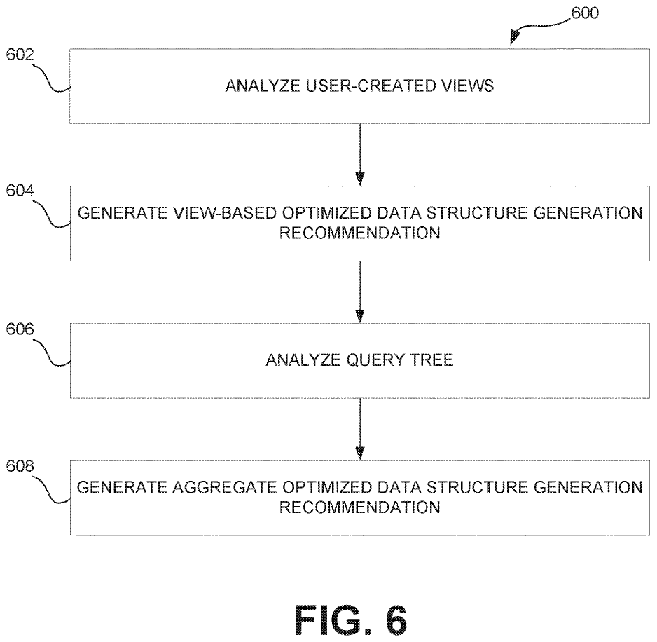

FIG. 6 depicts an example of processes performed by an optimized data structure recommendation module 600. This process includes operations that the data system 100 may execute to analyze query data and generate recommendations related to the generation and maintenance of new optimized data structures. For instance, the flow diagram shown in FIG. 6 may correspond to operations carried out, for example, by computing hardware found in the data system 100 as the computing hardware executes the optimized data structure recommendation module 600.

In some embodiments, the optimized data structure recommendation module 600 is configured to generate recommendations based on query data analyzed in the context of the query usage information determination module 500. For example, the data system 100 may generate recommendations for potential new optimized data structures that may be utilized to reduce computing resource usage when serving query responses. In particular embodiments, the data system 100 may utilize different techniques and/or combinations of techniques when generating optimized data structure recommendations. In some embodiments, the data system 100 may generate optimized data structure recommendations that are based on certain criteria and include a direct materialization of a user-created view. In still other embodiments, the data system 100 may generate recommendations as to the creation of new optimized data structures that include aggregate reflections based on certain criteria.

At operation 602, the data system, when executing the optimized data structure recommendation module 600, analyzes user-created views. In some embodiments, analyzing the user-created views includes traversing query plan trees top-down for one or more user-submitted queries. The system may then collect profile information for embedded views within the query. For example, the system may omit dynamic and/or non-deterministic functions in the query (e.g., a such functions may be unsuitable for optimized data structures of the type described herein). The system may further omit views that already have existing default raw reflections (e.g., raw reflections as discussed above).

In various embodiments, at operation 604, the data system 100 generates a view-based optimized data structure generation recommendation. In some embodiments, the view-based optimized data structure recommendation generations are generated based on query participation frequency for particular views. For example, in various embodiments, the data system 100 is configured to generate view-based optimized data structure recommendations by ranking particular views based on query participation frequency, and generating a recommendation that includes particular views that are included in at least a threshold number of queries. In other examples, the data system 100 generates the recommendation based on ranking the query participation frequency of particular views relative to views identified and analyzed as discussed herein. In this way, in some embodiments, the data system 100 is configured identify more frequently used views (e.g., relative to other views identified and analyzed in the context of the processes described herein) in order to generate recommendations that include optimized data structures that include views that are utilized more frequently than others.

In some embodiments, the system is configured to process the analysis of the user-created views using a rules-based model, a machine-learning model, or both to generate a recommendation for a view-based optimized data structure. In this way, the system may process the analysis to identify particular views that would provide the most benefit as reflections based on their frequency of appearance in queries.

At operation 606, the data system 100 analyzes a query tree for one or more particular queries. The system may then utilize the analysis to generate one or more aggregate optimized data structure recommendations. In some embodiments, when analyzing the query tree at operation 606, the data system 100 selects plan fragments (e.g., individual, executable portions of a larger query execution plan) that could match potential user queries. In doing so, the system is configured to select a first fragment. In some embodiments the first fragment is a fragment that includes a multi-join or aggregate fragment. The data system 100 is then configured to scan the query plan tree from the bottom up in order to identify potential plan fragments that can accelerate multiple queries. In selecting the first fragment, the data system 100 is configured to utilize particular criteria for identifying and selecting the particular fragment. For example, the data system may utilize criteria including whether a particular fragment includes a multi-join operation; whether the particular fragment includes logical aggregate nodes; whether the particular fragment uses nodes such as MultiJoin and/or LogicalValues to terminate the search in the query tree, etc.

At operation 608, the data system 100 generates the recommendation based on a set of optimized data structure recommendation generation rules. In some embodiments, the data system scans nodes above the terminating node and below the LogicalAggregate. In various embodiments, the data system 100 includes columns from filters, aggregates and projections in generating the recommendation. In still other embodiments, the data system defines dimensions and measures from the included columns. In particular, the set of rules defining recommendation generation may include a rule related to a frequency of use of a potential new optimized data structure, or other cost-savings factor or rule.

### Optimized Data Structure Efficacy Analysis Module

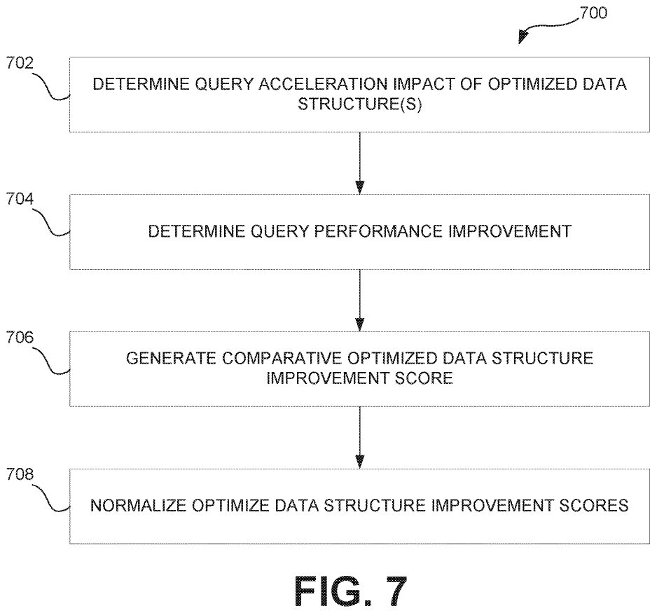

FIG. 7 depicts an example of processes performed by an optimized data structure efficacy analysis module 700. This process includes operations that the data system 100 may execute to analyze query acceleration impact of optimized data structures. For instance, the flow diagram shown in FIG. 7 may correspond to operations carried out, for example, by computing hardware found in the data system 100 as the computing hardware executes the optimized data structure efficacy analysis module 700.

At operation 702, the optimized data structure efficacy analysis module 700 determines query acceleration impact of one or more optimized data structures. The data system may, for example, measure query acceleration impact in terms of computing resource savings (e.g., versus a query for which one or more portions of a query plan were not replaced to the particular optimized data structure instead of the underlying data system). The data system may determine an average query savings for a particular optimized data structure over a set of queries for which a portion of a respective query plan included one or more substitutions from the particular optimized data structure. In some embodiments, the process involves determining usage frequency for each particular optimized data structure in a set of optimized data structures. The process may further involve determine a total cost savings based on an average savings and frequency of use. In this context of this disclosure, it should be understood that cost savings may include, for example, a reduction in query execution processing and/or time while maintaining the same query results. In other examples, a costs savings may include computing costs, reduction in distance-to-data, latency, and the like.

At operation 704, the data system 100 determines query performance improvement (e.g., for one or more optimized data structures). In some embodiments, the system compares query execution with and without each of the optimized data structures for which improvement data is desired. The system may compare a cost savings based on any suitable factor for a particular optimized data structure compared to query execution when that optimized data structure is not utilized.

At operation 706, the data system 100 generates a comparative optimized data structure improvement score. The system may, for example, use comparative optimized data structure improvement scores for one or more optimized data structures to compare query execution with and without the optimized data structures (e.g., to determine which optimized data structures or potential new optimized data structures in a set of optimized data structures would be the most beneficial in terms of cost savings and/or query execution improvement).

At operation 708, the data system 100 is configured to normalize optimized data structure improvement scores. In normalizing the scores, the system 100 may account for an age of particular optimized data structures, refresh frequency (which may require additional computational cost to maintain the particular data structure), and the like. This may, for example, account for optimized data structures that have been in use for longer and have a larger data set to demonstrate improvements in cost savings. The system may, for example, assign a relatively higher score to optimized data structures that have a lower query improvement in absolute terms than a newer optimized data structure, as such a data structure may have a demonstrated history of long term query performance improvement over a larger query sample. The system may further apply one or more adaptive scoring modifications that include, for example: (1) implementing a grace period for new optimized data structures; (2) prevents premature removal of recently created optimized data structure; (3) provides gradual, controlled optimization of an optimized data structure portfolio; and the like.

It should be understood in light of this disclosure that the system may weight optimized data structures that have been utilized for a longer period of time above potential new optimized data structures. Because the generation of new optimized data structures carries a computational cost, the system may factor in such an initial generation cost when determining whether a potential new optimized data structure is worth implementing.

### Optimized Data Structure Modification Module

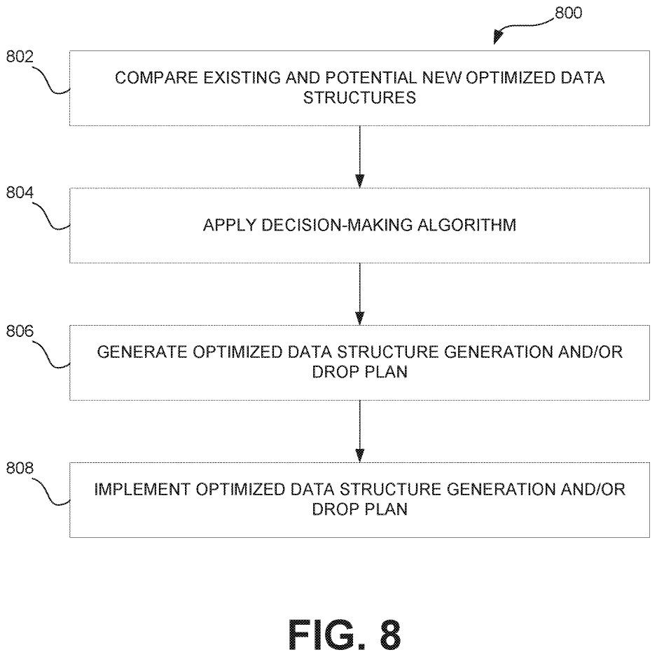

FIG. 8 depicts an example of processes performed by an optimized data structure modification module 800. This process includes operations that the data system 100 may execute to modify a set of optimized data structures to create new optimized data structures and/or drop existing optimized data structures based on efficacy analysis. For instance, the flow diagram shown in FIG. 8 may correspond to operations carried out, for example, by computing hardware found in the data system 100 as the computing hardware executes the optimized data structure modification module 800.

At operation 802, the optimized data structure modification module 800 compares existing and potential new optimized data structures. The data system 100 may, for example, compare the comparative optimized data structure improvement scores for an existing set of optimized data structures and one or more potential new optimized data structures (e.g., one or more recommended optimized data structures. As may be understood in light of this disclosure, while optimized data structures may provide a costs savings in terms of query execution, there may be a cost incurred in the initial generation and ongoing maintenance of an optimized data structure. As such, the data system 100 may limit a total number of optimized data structures that are maintained at a given time. In particular embodiments, when generating a new optimized data structure, the data system 100 may need to drop an existing optimized data structure. In doing so, the data system 100 may be configured to identify an optimized data structure to drop based on the comparison of the existing and potential new optimized data structures.

At operation 804, the data system 100 applies a decision-making algorithm to select optimized data structures for creation. In some aspects, the decision making algorithm further identifies one or more optimized data structures to be replaced in the set of optimized data structures. In this way, the system may be configured to maintain a maximum total number of optimized data structures in order to limit an overall cost of optimized data structure maintenance.

In some embodiments, the system uses a decision-making algorithm that prioritizes high-scoring recommendations. In various aspects, the decision making algorithm includes logic to drop optimized data structures that have an improvement score below a particular threshold. In other embodiments, the algorithm includes selection criteria. In some embodiments, the selection criteria include a cost improvement factor, usage count of each optimized data structure, an average running time with/and without a particular optimized data structure, an optimized data structure refresh time, and the like.

In some embodiments, the algorithm may apply one or more scoring boosts to each optimized data structure based on longevity. This may, for example, reduce optimized data reflection churn and the associated computing costs. In some embodiments, the system may limit creation of new optimized data structures to no more than a particular number over a particular time period (e.g., ten per day).

In particular embodiment, the data system 100 may process a set of current optimized data reflections along with: (1) a set of potential new optimized data structures (e.g., identified during a recommendation step described above); (2) the set of selection criteria; (3) optimized data structure creation limitations; and the like to identify an optimal set of optimized data structures. In some embodiments, the optimal set of optimized data structures may include the set of optimized data structures that provide the most improvement in cost saving while factoring in the other considerations described herein (computational cost of new optimized data structure creation, optimized data structure maintenance, system limitations, and the like). For example, the rules-based model, machine learning model, or combination of both may be configured to identify the optimal set of optimized data structures such that an overall costs savings from initial generation, to maintenance and query acceleration savings is expected to be the most impactful.

At operation 806, the optimized data structure modification module 800 generates an optimized data structure generation and/or drop plan. In some embodiments, the data system 100 generated the plan based on the results of the decision-making algorithm. The plan may, for example, include one or more identified optimized data structures do drop (e.g., to remove from the set of available optimized data structures) and one or more new optimized data structure to create. In some embodiments, the plan may include a timing plan for when to initiate any optimized data structure creation or dropping. In further embodiments, the plan may include an order in which to implement one or more portions of the plan.

At operation 808, the data system 100 is configured to implement the optimized data structure generation and/or drop plan. In some embodiments, the system is configured to implement the plan substantially automatically. In such embodiments, the system 100 is configured to create new optimized data structures and/or drop existing optimized data structures without input according to the plan (e.g., based on the plan timing, operation order, etc.). In other embodiments, the data system 100 is configured to create a plan recommendation and present the plan to a user (e.g., via a suitable graphical user interface) for review and approval prior to implementation. The system may, for example, enable to user to accept or reject individual portions of the plan in order to select which aspects of the plan the data system 100 implements or not.

### Query Maintenance Module

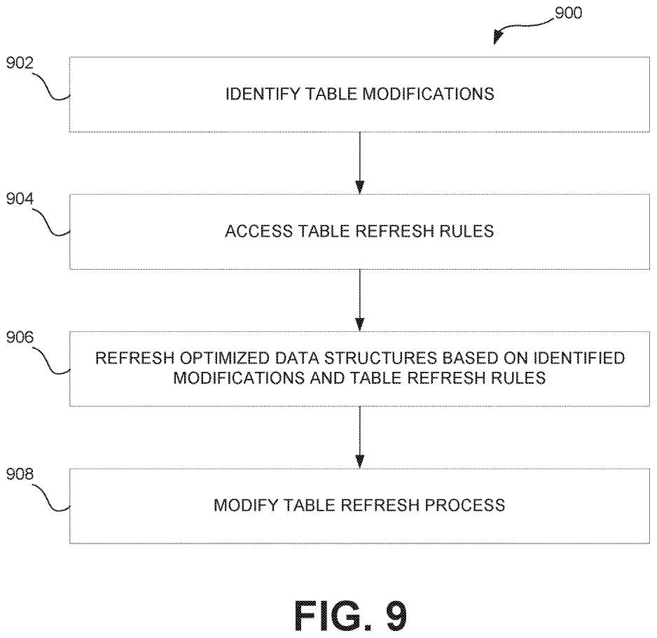

FIG. 9 depicts an example of processes performed by a query maintenance module 900. This process includes operations that the data system 100 may execute to maintain and refresh optimized data structures in response to modifications of the underlying data. For instance, the flow diagram shown in FIG. 9 may correspond to operations carried out, for example, by computing hardware found in the data system 100 as the computing hardware executes query maintenance module 900.

At operation 902, the system identifies table modifications. For example, the system may identify that a particular Iceberg table has been modified. In some aspects, the system may then identify one or more optimized data structures that are dependent on that table (e.g., include data from that table). In some embodiments, the system may utilize a polling mechanism to check Iceberg table snapshots. In some embodiments, the system may issue a request to the table's catalog according to a schedule (e.g., every ten seconds or other suitable frequency). The system may then compare a current snapshot ID with previous refresh points to determine when an optimized data structure requires updating.

At operation 904, the system accesses table refresh rules. In some embodiments the system may include refresh rules that indicate an automation of a refresh of an optimized data structure in response to identification of a table modification. In various aspects the rules may limit a number of simultaneous optimized data structure refresh to conserve computing resources. As such, in some embodiments, the system may be configured to prioritize refreshes of particular optimized data structure (e.g., optimized data structures that are used more frequently, have higher relative cost savings, etc.). In other embodiments, the system may limit a number of refreshes of a particular optimized data structure in a particular time period. In other embodiments, the system may limit a particular optimized data structure to a particular frequency of refresh. In some embodiments, the set of refresh rules may be universal (e.g., applicable to all optimized data structures). In other embodiments, the rules may apply specifically to particular optimized data structures or to a particular optimized data structure.

At operation 906, the system 100 may refresh the optimized data structures based on the identified modification according to the table refresh rules. The system may, for example, refresh each optimized data structure in an order and at a frequency determined based on the set of refresh rules.

At operation 908, the system may, in some embodiments, modify the table refresh process. For example, the system may modify the refresh process based on current system conditions. For example, the system may prevent duplicate refreshes where multiple underlying table changes occur substantially close together for a particular optimized data structure. The system may prevent automated optimized data structure refreshes during particular system operations (e.g., table optimizations and the like).

### Query Acceleration Module

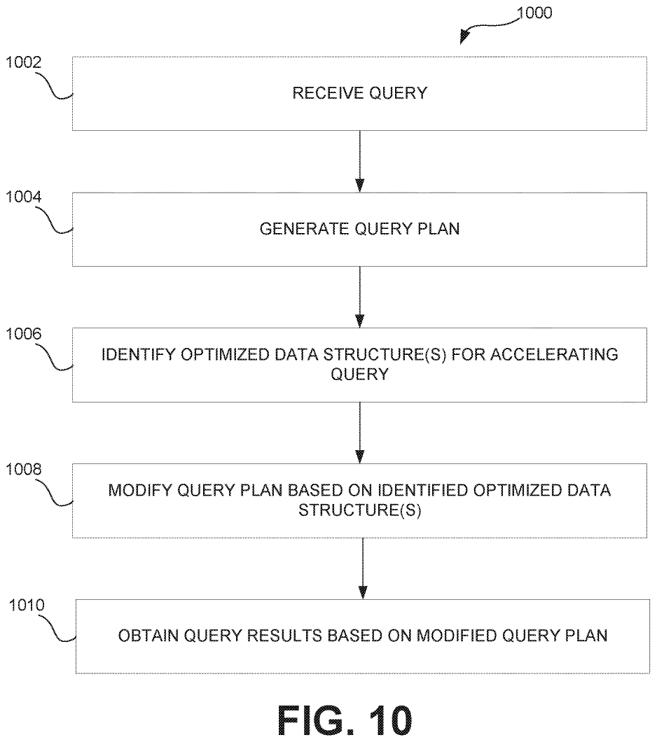

FIG. 10 depicts an example of processes performed by query acceleration module 1000. This process includes operations that the data system 100 may execute to modify query plans using optimized data structures. For instance, the flow diagram shown in FIG. 10 may correspond to operations carried out, for example, by computing hardware found in the data system 100 as the computing hardware executes the query acceleration module 1000.

At operation 1002, the data system 100 receives a query. In some embodiments, the query may refer to physical datasets and/or virtual datasets. The query may be received from a user device over a network coupled to a coordinator of the data system 100.

At operation 1004, the data system 100 generates a query plan based on the received query. For example, the query plan can define the operators that constitute the computation for the query. The data system may define the query plan based on a relational model and other considerations. For example, the query plan may be defined based on the collected information including the functional abilities of the data sources and other parameters. For example, a query plan may employ execution capabilities of a data source at a query planning phase, optimization phase, or query execution phase.

At operation 1006, the data system 1006 identifies one or more optimized data structures for accelerating the query. One example of a matching system is described below with respect to the optimized data structure matching module 1100.

At operation 1008, the data system 100 modifies the query plan based on the identified optimized data structure(s). In some embodiments, the system modifies the query plan to utilize optimized data structures in lieu of only querying the data sources directly for query results. In some embodiments, the original process for defining the query plan may consider any available reflections including their ordering, partitioning, and distribution. In other embodiments, the defined query plan is re-defined if optimized data structures that could accelerate query executions are identified. In some embodiments, the query plan may be broadened, modified to use optimized data structures, and/or modified to use the performance statistics discussed herein.

The data system 100 can determine whether the modified query plan only needs to read the selected optimized data structures to obtain query results or needs to read the data contained in the data sources as well. Therefore, the query execution is accelerated by reading the selected optimized data structures in lieu of reading at least some data from the data sources. On the other hand, if the query execution cannot be accelerated, the query plan is defined to read data from the data sources to compute the query results.

In some embodiments, an optimizer can optimize the query plan defining the execution of a query. The optimizer can explore opportunities to utilize optimized data structures contained in the relational cache rather than processing raw data in the data sources at query time. In some embodiments, the query results satisfying a query can be obtained more rapidly from the relational cache rather than directly from the data source. Further, the computational cost is reduced by utilizing the relational cache in lieu of data sources. As such, the optimizer may consider all the optimized data structures in the relational cache when a new query is received and automatically define a query plan to utilize optimized data structures when possible.

At operation 1010, the data system 100 obtains query results for the received query based on the modified query plan. In some embodiments, the system is configured to identify optimized data structures for use in generating a query plan prior to its generation. In such embodiment, a query plan may be executed as originally created rather than requiring modification from an initial plan. In some embodiments, execution of the modified query plan begins with one or more executors obtaining data into buffers from data sources. The executors can read physical datasets contained in remote data sources and/or reflections contained in the relational cache. The data is read while executing the modified query plan with a distributed or non-distributed query engine of the data system and/or the data sources. The data system 100 obtains query results that satisfy the received query. In some embodiments, intermediate query results obtained from data sources and/or the relational cache are combined to produce final query results that satisfy the query. For example, an executor can merge data from other executors to produce the final query results. The merged data can be streamed as final query results to a coordinator of the data system.

### Optimized Data Structure Matching Module

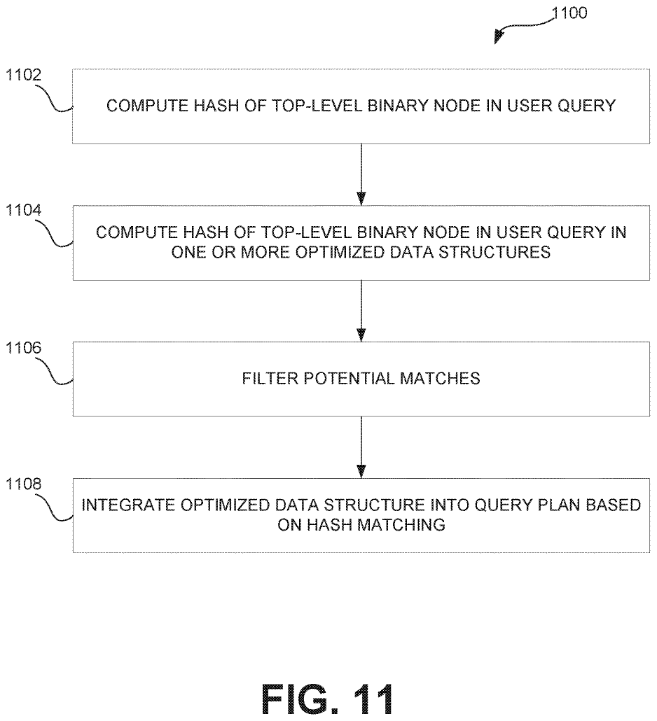

FIG. 11 depicts an example of processes performed by an optimized data structure matching module 1100. This process includes operations that the data system 100 may execute to match optimized data structures with queries for use in accelerating the queries. For instance, the flow diagram shown in FIG. 11 may correspond to operations carried out, for example, by computing hardware found in the data system 100 as the computing hardware executes the optimized data structure matching module 1100.

In some aspects, in order to match a new query with one or more potential optimized data structures for acceleration purposes the system may quickly identify portions of a query plan that have optimized data structures available for replacement. As such, the system may be configured to traverse a query tree for the query from the top down until the system identifies a first binary node that includes a join, union, or otherwise has multiple children. In some embodiments, the system is configured to hash from that node and below in order to produce a string that can be compared to hashes of nodes from optimized data structures for matching purposes. In some aspects, the system is configured to match anything above the identified first node in the query tree using one or more other matching techniques (e.g., algebraic matching). This may, for example, enable algebraic matching on filtering or other fragments above the first node, while not requiring traversal below the hashed node. This may, for example, conserve computing resources in matching query trees with existing optimized data structures.

At operation 1102, the data system 100 computes a hash of the top-level binary node in the user query (e.g., the user query received at operation 1002 discussed above). The system may use any suitable hashing function and/or algorithm to generate the hash. In some aspects, the system is configured to generate a hash for each top-level binary node in the user query. In some aspects, the system limits hashing to top-level nodes of a particular type (e.g., join, union, and the like) or to a particular number of top-level nodes. In some aspects, the system is configured to traverse a query tree until the system identifies a first top-level binary node suitable for hashing. The system may then use a second matching techniques for nodes above this identified first top-level binary node.

At operation 1104, the data system 100 computes a hash of the top-level binary node in one or more optimized data structures. In various embodiments, the system is configured to use the same hashing function when hashing the nodes in the optimized data structures to enable comparison between the hashes of the optimized data structure and query. In some aspects, the system is configured to generate a hash for each top-level binary node in each of the one or more optimized data structures. In some aspects, the system limits hashing to top-level nodes of a particular type (e.g., join, union, and the like). In particular aspects, the system hashes top-level nodes of the same type for which nodes were hashed in the user query itself at operation 1102.

At operation 1106, the data system 100 filters potential matches by comparing the hashes of the query’ node and/or nodes with each of the optimized data structure hashes (e.g., node by node). The system filters the potential matches to identify portions of a query that may be replaced with references to certain portions of optimized data structures that include a matching node (e.g., identified based on matching the respective hashes).

At operation 1108, the data system 100 integrated the optimized data structure(s) into the query plan based on the hash matching. In some embodiments, the system uses a bottom-up plan unification to integrate that optimized data structures when a match is identified at a particular node. In this way, the system is configured to enable matching complex queries without direct view references or complete column selection. In particular embodiments, the system is configured to match query plans within about 10 to 100 milliseconds, even for queries with hundreds of joins.

### Autonomous Optimized Data Implementation Module

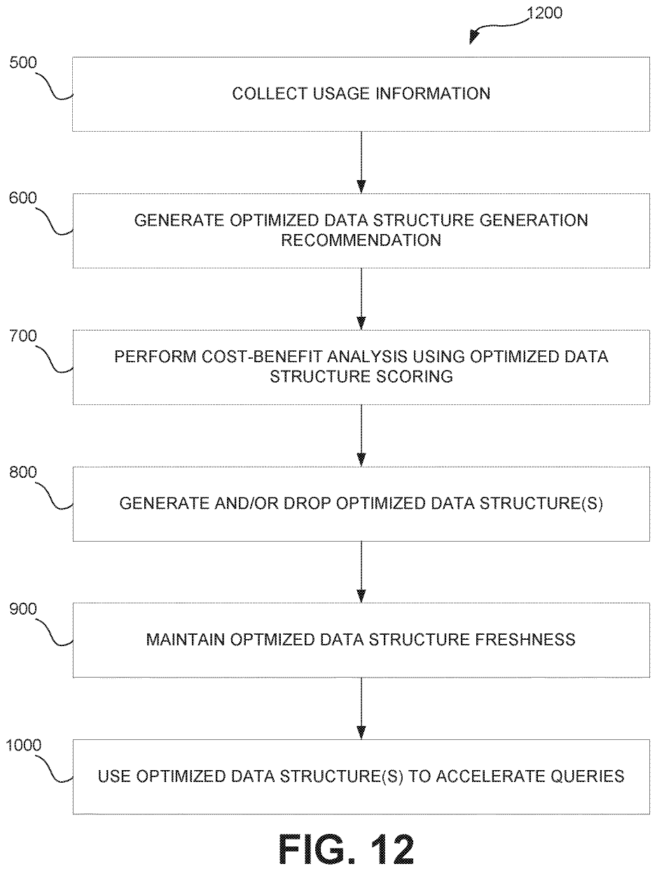

FIG. 12 depicts an example of processes performed by an autonomous optimized data structure implementation module 1200. This process includes operations that the data system 100 may execute for autonomously creating, dropping, and maintaining optimized data structures. For instance, the flow diagram shown in FIG. 12 may correspond to operations carried out, for example, by computing hardware found in the data system 100 as the computing hardware executes the autonomous optimized data structure implementation module 1200.

As may be understood from FIG. 12, at operation 500, the system collects query usage information. The system may utilize any suitable query usage collection techniques described herein. At operation 600, the system generates a recommendation as to the generation of a potential new optimized data structure. At operation 700, the system performs cost-benefit analysis using optimized data structure scoring. Next, at operation 800, the system generates and/or drops optimized data structures from a set of current optimized data structures. At operation 900 the system maintains optimized data structure freshness by modifying the optimized data in response to changes in the underlying data tables. At operation 1000, the system uses optimized data structures to accelerate queries and provide computational cost-savings in serving query responses.

### Computing System

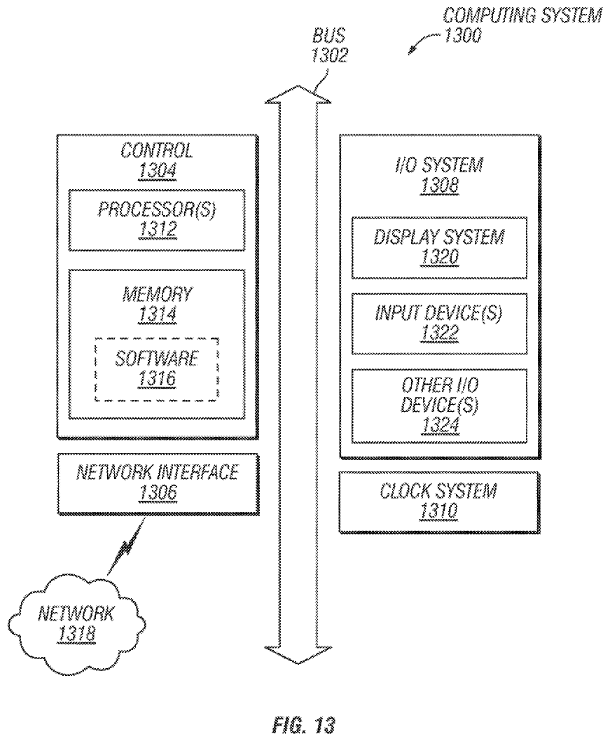

FIG. 13 is a diagrammatic representation of a computing system which can implement some embodiments of the present disclosure. Examples include any combination of the components of the data system 100. The computing system 1300 may be a general computer or a device specifically designed to carry out features of the disclosed technology. The computing system 1300 may be a network device, a system-on-chip (SoC), a single-board computer (SBC) system, a desktop or a laptop computer, a kiosk, a mainframe, a mesh of computer systems, a handheld mobile device, or combinations thereof.

The computing system 1300 may be a standalone device or part of a distributed system that spans multiple networks, locations, machines, or combinations thereof. In some embodiments, the computing system 1300 operates as a server computer (e.g., a network server computer running an analytic engine) or a mobile device (e.g., a user device of an enterprise network) in a networked environment, or a peer machine in a peer-to-peer system. In some embodiments, the computing system 1300 may perform one or more steps of the disclosed embodiments in real-time, near-real time, offline, by batch processing, or combinations thereof.

As shown, the computing system 1300 includes a bus 1302 operable to transfer data between hardware components. These components include a control 1304 (i.e., processing system), a network interface 1306, an Input/Output (I/O) system 1308, and a clock system 1310. The computing system 1300 may include other components not shown, nor further discussed for the sake of brevity. One having ordinary skill in the art will understand any hardware and software included but not shown in FIG. 13.

The control 1304 includes one or more processors 1312 (e.g., central processing units (CPUs), application-specific integrated circuits (ASICs), and/or field-programmable gate arrays (FPGAs)) and memory 1314 (which may include software 1316). The memory 1314 may include, for example, volatile memory such as random-access memory (RAM) and/or non-volatile memory such as read-only memory (ROM). The memory 1314 can be local, remote, or distributed.

A software program (e.g., software 1316), when referred to as “implemented in a computer-readable storage medium,” includes computer-readable instructions stored in a memory (e.g., memory 1314). A processor (e.g., processor 1312) is “configured to execute a software program” when at least one value associated with the software program is stored in a register that is readable by the processor. In some embodiments, routines executed to implement the disclosed embodiments may be implemented as part of operating system (OS) software (e.g., MICROSOFT WINDOWS, Linux) or a specific software application, component, program, object, module, or sequence of instructions referred to as “computer programs.”

As such, the computer programs typically comprise one or more instructions set at various times in various memory devices of a computer (e.g., computing system 1300) and which, when read and executed by at least one processor (e.g., processor 1312), cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., the memory 1314).

The network interface 1306 may include a modem or other interfaces (not shown) for coupling the computing system 1300 to other computers over the network 1318. The I/O system 1308 may operate to control various I/O devices, including peripheral devices such as a display system 1320 (e.g., a monitor or touch-sensitive display) and one or more input devices 1322 (e.g., a keyboard and/or pointing device). Other I/O devices 1324 may include, for example, a disk drive, printer, scanner, or the like. Lastly, the clock system 1310 controls a timer for use by the disclosed embodiments.

Operation of a memory device (e.g., memory 1314), such as a change in state from a binary one to a binary zero (or vice versa), may comprise a perceptible physical transformation. The transformation may comprise a physical transformation of an article to a different state or thing. For example, a change in state may involve accumulation and storage of charge or release of stored charge. Likewise, a change of state may comprise a physical change or transformation in magnetic orientation, or a physical change or transformation in molecular structure, such as from crystalline to amorphous or vice versa.

### Conclusion

Aspects of the disclosed embodiments may be described in terms of algorithms and symbolic representations of operations on data bits stored on memory. These algorithmic descriptions and symbolic representations generally include a sequence of operations leading to a desired result. The operations require physical manipulations of physical quantities. Usually, though not necessarily, these quantities take the form of electric or magnetic signals capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms, and that the disclosure applies equally regardless of the particular type of machine or computer-readable media used to actually effect the distribution.

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. A method comprising:
collecting, by computing hardware, query usage information;
generating, by the computing hardware, based on the query usage information, a recommendation as to the generation of a potential new optimized data structure;
performing, by the computing hardware, cost-benefit analysis for the potential new optimized data structure and each optimized data structure in a set of existing optimized data structures;
modifying by the computing hardware, the set of existing optimized data structures based on the recommendation and the cost-benefit analysis;
maintaining, by the computing hardware, the set of existing optimized data structures;
using, by the computing hardware, the set of existing optimized data structures to accelerate a query by inserting at least a portion of at least one optimized data structure in the set of existing optimized data structures into a query plan for the query.

2. The method of claim 1, wherein collecting the query usage information comprises:
monitoring, by the computing hardware, respective workload data for a set of queries;
filtering, by the computing hardware, the set of queries based on a set of criteria and the respective workload data;
analyzing, by the computing hardware, usage pattern and frequency data based on the filtering for the set of queries; and
categorizing, by the computing hardware, one or more query plan fragments from the set of queries.

3. The method of claim 2, wherein generating, by the computing hardware, based on the query usage information, the recommendation as to the generation of a potential new optimized data structure comprises causing, by the computing hardware, at least one of a rules-based model or a machine-learning model to process the one or more plan fragments, the usage pattern and frequency data, and the respective workload data to generate the recommendation as to generation of an optimized data structure for use in accelerating the one or more future queries, wherein the recommendation as to the generation of the optimized data structure for use in accelerating the one or more future queries comprises the potential new optimized data structure.

4. The method of claim 1, wherein performing the cost-benefit analysis for the potential new optimized data structure and each optimized data structure in the set of existing optimized data structures comprises:
determining, by the computing hardware, for the potential new optimized data structure and each respective existing optimized data structure in a set of existing optimized data structures, a respective query acceleration impact;
determining, by the computing hardware based on the respective query acceleration impact for the potential new optimized data structure and each respective existing optimized data structure in a set of existing optimized data structures, a respective query performance improvement factor;
generating, by the computing hardware based on the respective query performance improvement factor for the potential new optimized data structure and each respective existing optimized data structure in a set of existing optimized data structures, a respective comparative optimized data structure improvement score; and
normalizing, by the computing hardware, each respective comparative optimized data structure improvement score.

5. The method of claim 4, wherein:
normalizing each respective comparative optimized data structure improvement score comprises modifying each respective comparative optimized data structure improvement score based on at least one of an age or a refresh frequency each respective existing optimized data structure in the set of existing optimized data structures.

6. The method of claim 4, wherein determining the respective query acceleration impact comprises comparing execution of at least one query both with and without using at least a portion of the potential new optimized data structure and each respective existing optimized data structure in the set of existing optimized data structures.

7. The method of claim 4, wherein determining the respective query performance improvement factor comprises analyzing at least one of a usage frequency, average query savings, or total query savings for each respective existing optimized data structure in the set of existing optimized data structures.

8. The method of claim 7, wherein modifying the set of existing optimized data structures based on the recommendation and the cost-benefit analysis comprises:
applying, by the computing hardware, based on each respective normalized comparative optimized data structure improvement score, a decision-making algorithm to identify an optimal set of optimized data structures;
generating, based on the optimal set of optimized data structures, an optimized data structure generation plan; and
implementing, by the computing hardware, at least one step of the optimized data structure generation plan.

9. The method of claim 8, wherein implementing the at least one step of the optimized data structure generation plan includes modifying the set of existing optimized data structures to include the potential new optimized data structure and exclude a particular one of the set of existing optimized data structures.

10. The method of claim 8, wherein applying the decision-making algorithm comprises applying a set of selection criteria.

11. The method of claim 10, wherein the set of selection criteria comprise at least one of the respective query performance improvement factor; a respective usage count for each respective existing optimized data structure in the set of existing optimized data structures; or a refresh frequency for each respective existing optimized data structure in the set of existing optimized data structures.

12. The method of claim 11, wherein applying the decision-making algorithm comprises causing at least one of a rules-based model or a machine learning model to process the set of selection criteria and each respective normalized comparative optimized data structure improvement score to identify the optimal set of optimized data structures.

13. The method of claim 12, wherein the optimal set of optimized data structures comprises the set of optimized data structures that provide the greatest cost-savings with respect to system resource availability.

14. The method of claim 1, wherein inserting the at least a portion of the at least one optimized data structure in the set of existing optimized data structures into the query plan for the query comprises substituting the at least one optimized data structure in the set of existing optimized data structures into at least one plan segment of the query plan in lieu of a reference to an underlying data structure.

15. The method of claim 1, further comprising:
identifying, by computing hardware, a modification to an Iceberg table;
determining, by the computing hardware, which of the set of existing optimized data structures that are dependent on the Iceberg table;
accessing, by the computing hardware, a set of table refresh rules;
modifying, by the computing hardware, the set of existing optimized data structures based on the modification to the Iceberg table according to the set of table refresh rules.

16. A method comprising:
identifying, by computing hardware, a potential new optimized data structure for use in accelerating one or more future queries;
determining, by computing hardware, for the potential new optimized data structure and each respective existing optimized data structure in a set of existing optimized data structures, a respective query acceleration impact;
determined, by the computing hardware based on the respective query acceleration impact for the potential new optimized data structure and each respective existing optimized data structure in a set of existing optimized data structure, a respective query performance improvement factor;
generating, by the computing hardware based on the respective query performance improvement factor for the potential new optimized data structure and each respective existing optimized data structure in a set of existing optimized data structures, a respective comparative optimized data structure improvement score;
normalizing, by the computing hardware, each respective comparative optimized data structure improvement score;
applying, by the computing hardware, based on each respective normalized comparative optimized data structure improvement score, a decision-making algorithm to identify an optimal set of optimized data structures;
generating, based on the optimal set of optimized data structures, an optimized data structure generation plan; and
implementing, by the computing hardware, at least one step of the optimized data structure generation plan.

17. The method of claim 16, wherein implementing at least one step of the optimized data structure generation plan includes modifying the set of existing optimized data structures to include the potential new optimized data structure and exclude a particular one of the set of existing optimized data structure.

18. The method of claim 16, wherein applying the decision-making algorithm comprises applying a set of selection criteria.

19. The method of claim 18, wherein the set of selection criteria comprise at least one of the respective query performance improvement factor; a respective usage count for each respective existing optimized data structure in the set of existing optimized data structures; or a refresh frequency for each respective existing optimized data structure in the set of existing optimized data structures.

20. The method of claim 16, further comprising:
monitoring, by computing hardware, respective workload data for a set of queries;
filtering, by the computing hardware, the set of queries based on a set of criteria and the respective workload data;
analyzing, by the computing hardware, usage pattern and frequency data based on the filtering for the set of queries;
categorizing, by the computing hardware, one or more query plan fragments from the set of queries; and
causing, by the computing hardware, at least one of a rules-based model or a machine-learning model to process the one or more plan fragments, the usage pattern and frequency data, and the respective workload data to generate a recommendation as to generation of an optimized data structure for use in accelerating the one or more future queries, wherein the recommendation as to the generation of the optimized data structure for use in accelerating the one or more future queries comprises the potential new optimized data structure.
